(19) United States
(12) Patent Application Publication
(10) Pub. No.: US 2008/0237304 A1
(43) Pub. Date: Oct. 2, 2008

(54) Engine component having friction welded inserts

(75) Inventors: Michael Don Bridges, Iuka, MS (US); Christopher Anthony Kinney, Iuka, MS (US); Douglas A. Rebinsky, Peoria, IL (US); Bradley Thomas Bonds, Tishomingo, MS (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/730,385

(22) Filed: Mar. 30, 2007

(51) Int. Cl. B23K 20/12

(52) U.S. Cl. 228/112.1

(57) ABSTRACT

A method of repairing an integral engine component is disclosed. The method of repairing the integral engine component may include removing a damaged portion of a first member to create a void. The method of repairing the integral engine component may also include friction welding in place a second member to at least partially fill the void.

### TECHNICAL FIELD

The present disclosure relates generally to an engine component, and more particularly, to an engine component having friction welded inserts.

### BACKGROUND

An internal combustion engine generally includes one or more combustion chambers that house a combustion process to produce mechanical work and a flow of exhaust. Each combustion chamber is formed from a cylinder, the top surface of a piston, and the bottom surface of a cylinder head. The cylinder head is typically fabricated from a gray iron casting or an aluminum casting having cast-in-place gray iron inserts. Air or an air/fuel mixture is directed into the combustion chamber by way of intake ports disposed in the cylinder head, and the resulting exhaust flow is discharged from the combustion chamber by way of exhaust ports also disposed in the cylinder head. Valves are located within the ports of the cylinder head and seal against valve seats to selectively allow and block the flows of air and exhaust.

During engine operation, the gray iron cylinder head or cylinder head inserts are exposed to high pressures and temperatures and, over time, these high pressures and temperatures can cause deterioration of the cylinder head's bottom surface, valve seats, exhaust ports, and other components of the cylinder head. As engine manufacturers are continually urged to increase fuel economy, meet lower emission regulations, and provide greater power densities, cylinder pressures and combustion gas temperatures within the combustion chamber have been increasing. Soon, gray iron cylinder heads and cylinder head inserts fabricated with today's technology may be unable to withstand the increasing pressures and temperatures.

One solution to the increasing pressures and temperatures described above is disclosed in U.S. Pat. No. 5,215,050 (the '050 patent) issued to Rüickert et al. on Jun. 1, 1993. The '050 patent describes a method of producing aluminum cylinder heads having a heat-resistant base plate fitted into the combustion-chamber-side base wall. The method includes friction welding the heat resistant base plate fabricated from a dissimilar metal to the newly formed aluminum cylinder head. The base plate and cylinder head have predetermined complementary shapes, such that prior to friction welding, their joining surfaces have a relatively small, shared central surface area. The preformed cylinder head contains blind gas-exchange channels terminating near the firedeck of the cylinder head, and the base plate has a closed joining surface. Following friction welding, the combustion chamber is connected to the gas exchange channels by machining through the base plate. The cylinder head is fabricated from a cast aluminum material commonly used for cylinder heads. The base plate is made of a highly heat resistant aluminum material reinforced by Al₂O₃ fibers.

Although the method of the '050 patent may be used to fabricate new aluminum cylinder heads with improved firedeck heat resistance and strength, it may suffer from residual stresses caused by the friction welding process and may result in cracks when used with a material other than aluminum. In addition to being restricted to aluminum cylinder heads, the method of the '050 patent may be costly and its applicability further limited. Specifically, the '050 patent does not address components that may have already failed due to thermal fatigue. Furthermore, because the combustion chamber described in the '050 patent must be specially designed to have gas-exchange channels ending blind near the combustion wall, and each of the workpieces must have a small shared surface area prior to welding, these workpieces may be difficult to machine and their cost may be excessive. Additionally, their applicability may be limited to planer surfaces such as the firedeck of the cylinder head, as the restriction on surface geometry may be inappropriate for components having no central structure, such as the exhaust port liners and valve seats.

The disclosed cylinder head is directed to overcoming one or more of the problems set forth above.

### SUMMARY OF THE DISCLOSURE

In one aspect, the present disclosure is directed to a method of repairing an integral engine component. The method of repairing the integral engine component may include removing a damaged portion of a first member to create a void. The method of repairing the integral engine component may also include friction welding in place a second member to at least partially fill the void.

In another aspect, the present disclosure is directed to another method of repairing an integral engine component. The method of repairing the integral engine component may include disassembling a cylinder head from an engine and forming a void in the cylinder head. The method of repairing the integral engine component may also include friction an insert in place relative to the cylinder head to at least partially fill the void. Both the members may be heated prior to welding.

In yet another aspect, the present disclosure is directed to an integral engine component. The integral engine component may include a first member having a void created after manufacture and operation of the component. The integral engine component may also include a second member friction welded to fill the void.

### BRIEF DESCRIPTION OF THE DRAWINGS

FIG. 1 is a pictorial illustration of an exemplary disclosed engine;

FIG. 2 is a pictorial illustration of an exemplary disclosed cylinder head for use with the engine of FIG. 1;

FIG. 3 illustrates an exemplary process for joining components of dissimilar materials in the cylinder head of FIG. 2;

FIG. 4A is cross-sectional illustration of an exemplary friction welded insert associated with the process of FIG. 3; and

FIG. 4B is another cross-sectional illustration of an exemplary friction welded insert associated with the process of FIG. 3.

### DETAILED DESCRIPTION

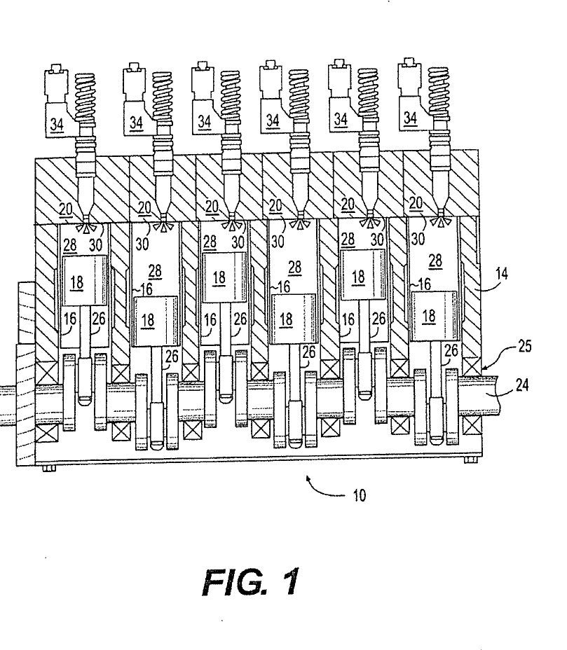

FIG. 1 illustrates an exemplary engine 10. For the purposes of this disclosure, engine 10 is depicted and described as a four-stroke diesel engine. One skilled in the art will recognize, however, that engine 10 may be any other type of internal combustion engine such as, for example a diesel engine, a gasoline engine or a gaseous fuel-powered engine. Engine 10 may include an engine block 14 that defines a plurality of cylinders 16, a piston 18 slidably disposed within each cylinder 16, and a cylinder head 20 associated with each cylinder 16. The engine 10 may also include a crankshaft 24 that is rotatably supported within engine block 14 by way of a plurality of journal bearings 25. A connecting rod 26 may connect each piston 18 to crankshaft 24 so that a sliding motion of piston 18 within each respective cylinder 16 results in a rotation of crankshaft 24 within journal bearings 25. The cylinder 16, piston 18, and cylinder head 20 together may form a combustion chamber 28.

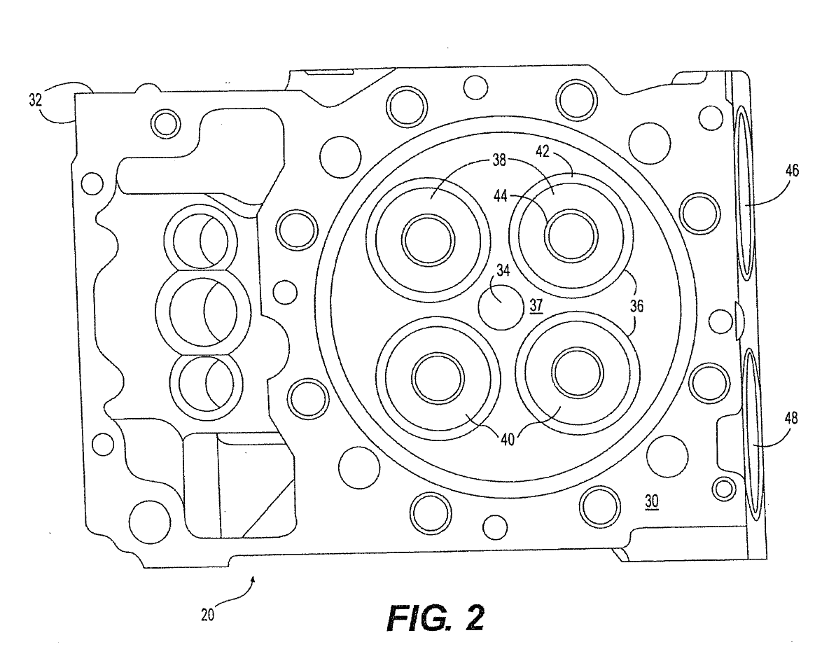

Referring to FIG. 2, cylinder head 20 may include a bottom deck, or firedeck surface 30, a plurality of side surfaces 32 and a top surface (not shown). Firedeck surface 30 of cylinder head 20 may be fastened to engine block 14 (referring to FIG. 1) of engine 10, in a typical manner. Firedeck surface 30 of cylinder head 20 may include a fuel injector opening 34 and two or more valve pockets 36, the area between valve pockets 36 forming a valve bridge 37. As illustrated, valve pockets 36 may include a pair of exhaust valve pockets 38 and a pair of intake valve pockets 40. Valve pockets 36 may be evenly spaced about fuel injector opening 34. Each valve pocket 36 may include a valve seat 42 and a valve guide 44. A passage (not shown) may be defined within the cylinder head 20 extending from each valve pocket 36 to a respective one of an exhaust port 46 and an intake port 48. The exhaust and intake ports 46, 48 may be defined in one of the side surfaces 32 of the cylinder head 20. Internally, cylinder head 20 may include a plurality of fluid passages (not shown). The fluid passages include, for example, coolant and lubrication passages. The coolant and lubrication passages may function in a conventional fashion.

Valve seats 42, valve guides 44, firedeck surface 30 and exhaust port 46 may, in a typical arrangement, be cast integral to the cylinder head 20, and then may be machined to precise dimensions during a second process. However, in the embodiments of this disclosure, it may be desirable to remove damaged portions of these components and replace them with material inserts that may vary in their material composition.

As one example, the material chosen to cast the bulk of cylinder head 20 may have an oxidation resistance too low to sustain a load that may, in some situations, be as great as 22 MPa and 400° C. within combustion chamber 28 or at exhaust port 46. Cylinder head 20, for example, may overheat due to improper cooling and as a result, a crack (not shown) may propagate in valve bridge 37. Thus, it may be desirable to remove the area of damage and replace it with an insert of the same material composition or a second material with improved thermal strength. The second material may be inappropriate for use throughout cylinder head 20 due to cost and machinability, but when strategically located, the inserts may improve the reliability of the thermally loaded components and increase the overall service life of cylinder head 20. A further example may use the thermal conduction properties of a second material insert in cylinder head 20 to isolate heat in combustion chamber 28 from other engine components, thereby increasing the efficiency of engine 10. The use of a stronger insert with better oxidation resistance may eliminate the need for liquid cooling throughout all or a portion of cylinder head 20, thereby reducing the design, manufacturing and maintenance complexity of cylinder head 20.

In general, the base portion of cylinder head 20 (i.e. that portion of cylinder head 20 consuming the largest volume) may be fabricated from an inexpensive and easily machinable material such as, for example, gray cast iron. Gray cast iron may have a melting temperature of about 1150-1160° C., a Brinell hardness number of about 183-234 and an ultimate tensile strength of about 280-360 MPa. Inserts that are friction welded as firedeck surface 30, valve seats 42, valve guides 44, exhaust port 46 and other areas of cylinder head 20 or engine 10 may be fabricated from gray cast iron or from any material having improved thermal and mechanical properties, as compared to gray cast iron. For example, these components may be fabricated from any one of the materials listed in Table 1 below.

TABLE 1

| | | | | Ultimate |
|---|---|---|---|---|
| | | | | Tensile |
| | | Melting Temp. | Hardness | Strength |
| Description | Composition (Wt %) | (° C.) | (Brinell) | (MPa) |
| Inconel 600 ® | 72Ni Min; 14Cr Min; | 1260 | 180 | 400 |
| | 3C; 2.5Si; 0.8Mn; | | | |
| | 0.030Mg; balance Fe | | | |
| Mild Steel | 2C Max; balance Fe | 1520 | 120–143 | 420 |
| Ductile Iron | 0.03–0.05Mg; 2.2–2.8Si; | 1120 | 143–220 | 379 Min |
| | 0.01–0.5Mn; | | | |
| | 0.005–0.02S; 0.005–0.04P; | | | |
| | 3.3–3.4C; | | | |
| | balance Fe | | | |
| 300 Austenitic | 26Cr Max; 2.0Si Max; | 1400–1450 | 126–230 | 510–620 |
| Stainless | 2.0Mn; 0.25C Max; 22 | | | |
| | Ni Max; balance Fe | | | |

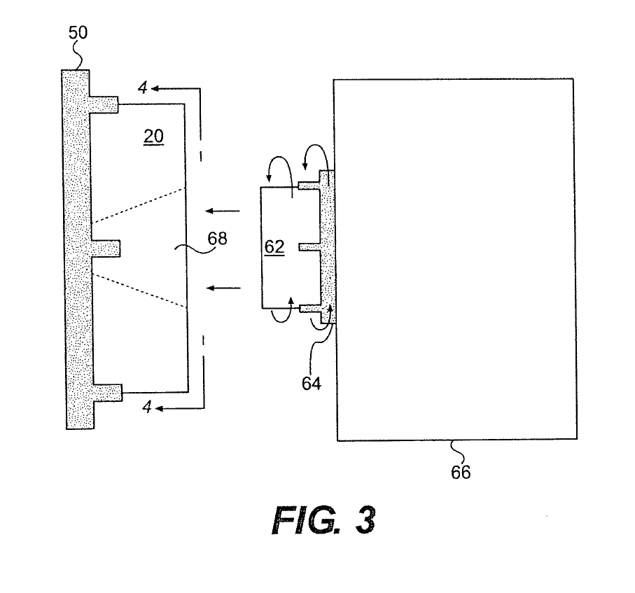

FIG. 3 illustrates an exemplary process for joining components of similar or dissimilar materials in cylinder head 20. The setup for this process may include a stationary chuck 50, a cylinder head 20 placed into chuck 50, and an insert 62 placed into rotatable chuck 64 of a friction welding device 66.

Cylinder head 20 may have had a damaged portion removed by machining or a similar process in an area of high stress, such as firedeck surface 30 (referring to FIG. 2), to form a void 68. Referring to the example of a cracked valve bridge 37, it may be desirable to remove a large damaged portion of firedeck surface 30 (i.e. the entire firedeck area) and replace it with a second material so that further damage may be avoided. The depth of void 68 may be substantially uniform and may be determined by the depth of the crack or other damage. That is, the entire damaged portion should be removed. While removing the damaged area, an effort to avoid penetrating the coolant passages may be made. It is also considered that one or more valve pockets 36 may be damaged and it may be desirable to remove and reform all valve pockets 36 together with valve bridge 37. In this example, void 68 may be tapered, such that when cylindrical insert 62 having a generally square end surface, is received by void 68 the area of contact may be limited to a ring perimeter. It is further considered that the diameter of void 68 may be dependant upon the availability of stock material for use as insert 62. That is, in order to receive insert 62 of a predetermined diameter, it may be necessary for void 68 to have a diameter larger than required to only remove the damaged area.

Insert 62 may be a preformed disk of circumference and depth similar to that of the newly created void 68. The diameter of insert 62 may be determined by the availability of standard stock size cylindrical bars or, alternatively, may be determined by the diameter of void 68. That is, insert 62 may be machined or similarly fashioned to match the diameter of void 68. Insert 62 may, on one end, be machined or similarly fashioned in include a star, hexagonal or square pattern to be received by rotatable chuck 64. Prior to welding, cylinder head 20 and insert 62 may be heated to above approximately 900° C. with, for example, an oxyacetylene torch or an induction coil (not shown). Heating to this temperature may relieve the thermal stresses within the gray iron and may prevent cracking of the weld due to thermal strain induced during the welding process.

Friction welding device 66 may include a flywheel (not shown) connected to rotatable chuck 64. The flywheel may be accelerated by a drive motor (not shown) to a predetermined rotational speed, thereby kinetically storing the energy required by the welding process. At a predetermined time, the drive motor may be disengaged from the flywheel, and rotating insert 62 may be driven into cylinder head 20 by friction welding device 66 for a finite amount of time at a predetermined pressure. The welding time may, at least in part, be determined by the amount of energy stored in the flywheel. Friction welding device 66 may alternatively be a continuously driven device, in which chuck 64 may be connected to a continuously running electric motor.

The rotational speeds and axial loads of the welding process may, for example, be dependant upon the application, material and/or geometry of insert 62, as shown in Table 2. In general, materials with greater hot strength will require spindle speeds and friction forces greater than those with lower hot strength. For the purposes of this disclosure, the term “hot strength” refers to the ultimate tensile strength of the material as it approaches its melting point. For example, a stainless steel bar six inches in diameter may require a forge force of approximately 400,000 lbs at a rotational speed of 150 rpm while mild steel bar of the same diameter may require a forge force of approximately 200,000 lbs at a rotational speed of 100 rpm.

TABLE 2

| | | | | | | Duration |
|---|---|---|---|---|---|---|
| | | | | | | of axial |
| | | | | | | load |
| | | | Initial | | | after |
| | Insert | Spindle | Friction | Forge | Forge | rotation |
| | Diameter | Speed | Force | Speed | Force | ceases |
| Application | (in) | (rmp) | (lb) | (rpm) | (lb) | (sec) |
| Firedeck | 5–6 | 100–400 | 100,000–300,000 | 100–200 | 200,000–600,000 | 15 |
| Surface | | | | | | |
| Insert | | | | | | |
| Valve Seat | 1.5–2.5 | 1500–2500 | 25,000–40,000 | 1000–2000 | 50,000–80,000 | 10 |
| Insert | | | | | | |

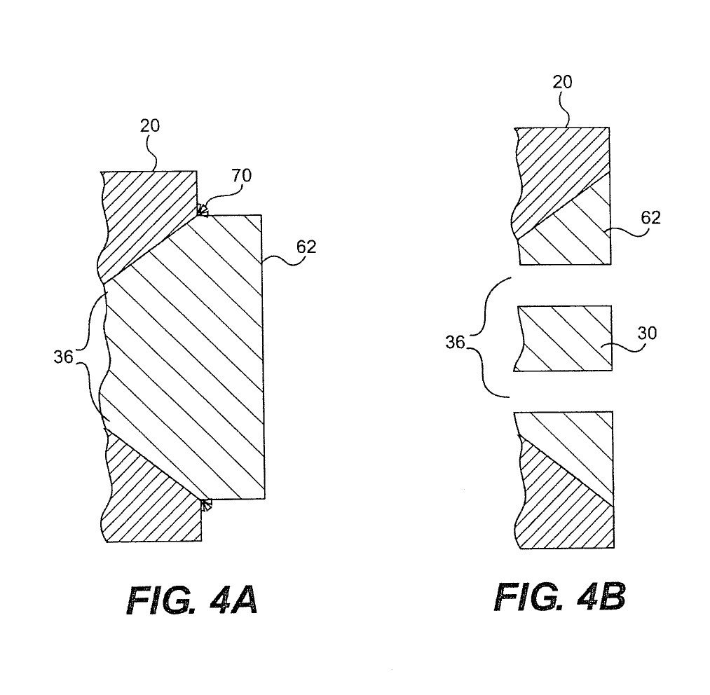

FIG. 4A is a cross-sectional illustration of an exemplary friction welded insert associated with the process illustrated in FIG. 3. During the friction welding process flash 70 may be produced as material at a boundary layer between cylindrical head 20 and insert 52 is driven radially outward to a perimeter of the resulting weld. Referring to FIG. 4B, portions of insert 62 and flash 70 may be removed by machining or similar operation to create firedeck surface 30, flush with cylinder head 20, as shown in FIG. 4B. Valve pockets 36 may also be extended through insert 62 in a typical fashion, after the welding process is complete.

### INDUSTRIAL APPLICABILITY

The method of repair presently disclosed may be applicable to a wide variety of engine components including, for example, a cylinder head having a friction welded firedeck surface, valve seats, valve guides and/or valve ports; and an engine block having friction welded cylinder liners, journal bearings or other features. The disclosed integral engine component may allow for the repair and continued use of damaged engine components. In addition, the use of friction welded inserts may improve the thermal resistance and strength of the engine, thereby allowing for greater pressures and temperatures within the combustion chamber at an overall lower cost. An exemplary method for friction welding similar or dissimilar materials in an engine component will now be described in detail with reference to FIGS. 3, 4A and 4B.

Referring to FIG. 3, in one embodiment, the first member, for example a gray iron cylinder head 20 may be cast into a mold (not shown) or otherwise fabricated. During engine operation, areas subject to high stress, for example the cylinder head's firedeck surface, valve seats and exhaust ports, may be damaged, and later removed by machining or a similar process to form void 68. For example, two exhaust valve pockets 38 may be cracked and it may be desirable to replace all four valve pockets 36 and form a new fireside surface 30 and valve bridge 37. The area machined away may, for example, encompass all four valve seats, have an initial diameter of six inches, and have a resulting taper angle of about 120°. Insert 62 may, for example, be a six-inch diameter cylindrical Inconel® bar. Cylinder head 20 may be placed into stationary chuck 50 and insert 62 may be placed into rotatable chuck 64 of friction welding device 66. Cylinder head 20 and insert 62 may be heated, for example with an oxyacetylene torch or an induction coil, to above about 900° C. prior to welding.

To achieve the weld between cylinder head 20 and insert 62, chuck 64 may be rotated, for example to 400 rpm and insert 62 may be driven into cylinder head 20 with a predetermined initial axial friction force, for example 300,000 lbs. The friction force may heat the initial contact perimeter between insert 62 and cylinder head 20 and as these surfaces become plastic, the area of contact may increase. As the rotational speed of insert 62 decreases due to the contact between cylinder head 20 and insert 62, the axial load may be increased, for example to about 600,000 lb, to induce forging between cylinder head 20 and insert 62. Rotation may stop when the stored energy in welding device 66 has been consumed in the weld. The axial load may be maintained for a predetermined length of time, for example 15 seconds after rotation ceases, to allow the weld to solidify. Conventional tempering temperatures and techniques may be used to achieve desired hardness throughout the heat affected zone.

Referring to FIG. 4A, an excess portion of insert 62 and flash 70 may protrude from the surface of the cylinder head 20. Insert 62 and flash 70 may be machined or otherwise removed to create a firedeck surface 30, substantially flush with cylinder head 20, as shown in FIG. 4B. Valve pockets 36 may also be extended through insert 62, and valve seats 42 and valve guides 44 (referring to FIG. 2) may be machined to precise dimensions in a typical fashion.

Several advantages over the prior art may be associated with the integral combustion engine component of the present disclosure. Specifically, the disclosed process may be used in conjunction with gray iron cylinder heads that may have already been damaged, and may allow flexibility in design constraints such as shape, size and material properties. The advantages provided by the present disclosure may allow the construction of components capable of withstanding the pressures and temperatures of today's engines. The selective use of material for the inserts may allow for improved thermal properties without the increased cost associated with the use of the material throughout the entire engine block or cylinder head. Furthermore, the flexibility afforded by the present disclosure may allow selection of materials with desirable thermal conduction properties and their placement throughout the cylinder head in a manner that may eliminate the need for the fluid passages that conventionally function in a cooling circuit capacity. The present disclosure may achieve these advantages with a welding process capable of joining gray iron with similar and dissimilar metals, without requiring specific and expensive cylinder head geometry.

It will be apparent to those skilled in the art that various modifications and variations can be made to the disclosed cylinder head. Other embodiments will be apparent to those skilled in the art from consideration of the specification and practice of the disclosed cylinder head. It is intended that the specification and examples be considered as exemplary only, with a true scope being indicated by the following claims and their equivalents.

1. A method of repairing an integral engine component, comprising:
removing a damaged portion of a first member to create a void; and
friction welding in place a second member to at least partially fill the void, wherein the friction welding includes friction welding the second member having a strength greater than the first member.

2. (canceled)

3. The method of claim 1, wherein the removing includes removing a damaged portion from the first member that is composed of cast grey iron, and
the friction welding includes heating the first and second members to approximately 900° C. prior to friction welding.

4. The method of claim 1, wherein the removing includes creating a void is tapered at an outer periphery.

5. The method of claim 1, wherein:
the friction welding includes friction welding a second member that is approximately six inches in diameter and composed of stainless steel; and
the friction welding is achieved with a forge speed of approximately 150 rpm and a forge force of approximately 400,000 lbs.

6. The method claim 1, wherein:
the friction welding include friction welding a second member that is approximately six inches in diameter and composed of mild steel; and
the friction welding is achieved with a forge speed of approximately 100 rpm and a forge force of approximately 200,000 lbs.

7. A method of repairing an integral engine component, comprising:
disassembling a cylinder head from an engine;
forming a void in the cylinder head;
friction welding an insert in place relative to the cylinder head to at least partially fill the void, wherein the insert has a strength greater than the cylinder head; and
heating both the cylinder head and insert prior to friction welding.

8. The method of claim 7, wherein the forming includes forming a void in an area of the cylinder head that has been damaged.

9. (canceled)

10. The method of claim 7, wherein the removing includes forming a void that is tapered at an outer periphery.

11. The method of claim 7, wherein
the friction welding includes friction welding an insert that is approximately six inches in diameter and composed of stainless steel; and
the friction welding is achieved with a forge speed of approximately 150 rpm and a forge force of approximately 400,000 lbs.

12. The method of claim 7, wherein:
the friction welding includes friction welding an insert that is approximately six inches in diameter and composed of mild steel; and
the friction welding is achieved with a forge speed of approximately 100 rpm and a forge force of approximately 200,000 lbs.

13. An integral engine component, comprising:
a first member having a void created after manufacture and operation of the component; and
a second member friction welded to fill the void, wherein the second member has a strength greater than the strength of the first member.

14. (canceled)

15. The integral engine component of claim 13, wherein the first member is composed of cast gray iron.

16. The integral engine component of claim 15, wherein the second member is composed of stainless steel.

17. The integral engine component of claim 15, wherein the second member is composed of mild steel.

18. The integral engine component of claim 15, wherein the second member is composed of a material with a percent weight material composition of approximately: 72Ni Min; 14Cr Min; 3C; 2.5Si; 0.8Mn; 0.030Mg; balance Fe.

19. The integral engine component of claim 13, wherein the void is tapered at an outer periphery.

20. The integral engine component of claim 13, wherein the first member includes a cylinder head.
